(19) United States
(12) Patent Application Publication
(10) Pub. No.: US 2013/0129867 A1
(43) Pub. Date: May 23, 2013

(54) AGGLOMERATED PROTEIN COMPOSITION

(71) Applicant: NICOLAS DEAK, ST. LOUIS, MO (US)

(72) Inventor: NICOLAS DEAK, ST. LOUIS, MO (US)

(21) Appl. No.: 13/679,834

(22) Filed: Nov. 16, 2012

Related U.S. Application Data
(60) Provisional application No. 61/561,608, filed on Nov. 18, 2011.

(51) Int. Cl. A23J 3/00

(52) U.S. Cl. CPC A23J 3/00
USPC 426/72; 426/656; 426/657; 426/654; 426/590; 426/594; 426/599

(57) ABSTRACT

The present invention relates to compositions and methods for producing an agglomerated protein composition comprising at least one acid soluble protein.

### CROSS REFERENCE TO RELATED APPLICATIONS

This application claims priority from U.S. Provisional Application Ser. No. 61/561,608 filed on Nov. 18, 2011.

### FIELD OF THE INVENTION

The present invention generally relates to an agglomerated protein composition. More specifically, the invention is to an agglomerated protein composition comprising at least one acid soluble protein for use in food products.

### BACKGROUND OF THE INVENTION

Acid soluble proteins typically have less than desirable dispersibility. The acid soluble protein tends to float on the surface of the aqueous slurry that it is being mixed with and takes a long time to go into solution. Thus, acid soluble proteins can be difficult to mix or incorporate into beverages and other food products. Therefore, there is a need for an acid soluble protein that can be easily incorporated into beverages and other food products.

Generally, acid soluble proteins do not perform well in pH ranges that are not mildly acidic or acidic. Due to this, acid soluble proteins also do not perform well in the presence of certain other food ingredients, such as chelating agents, salts, and sugars. There is a need for an acid soluble protein that can perform in non-acidic pH ranges.

In some cases animal proteins such as collagen or hydrolyzed collagen are highly functional, but their nutritional value is very limited. In other cases such as caseins, and egg albumins their nutritional value is high but their functionality is limited. There is a need for such products to both have a good nutritional value and functionality.

### SUMMARY OF THE INVENTION

The present invention is to an agglomerated protein composition, comprising an acid soluble protein isolate. In addition to the acid soluble protein isolate, the agglomerated protein can further include any protein known in the art. Proteins include but are not limited to vegetable proteins, animal proteins, dairy proteins, and mixtures thereof. Vegetable proteins include but are not limited to oilseed proteins, pea proteins, corn proteins and mixtures thereof. Oilseed proteins include but are not limited to soy protein and canola protein.

In an additional embodiment the agglomerated protein composition further comprises, in addition to the at least one acid soluble protein, at least one hydrocolloid, sugar, flavoring agent, vitamin, mineral, antioxidant, and combinations thereof. This embodiment may also contain at least one other protein.

The present invention is also directed to a method of using the agglomerated protein composition in food products.

The current invention demonstrates a process, compositions, and method of using an agglomerated protein composition.

### BRIEF DESCRIPTION OF DRAWINGS

FIG. 1 is a flowchart depicting the simple agglomeration of the acid soluble isolated protein ingredient as disclosed in Example 1.

FIG. 2 is a flowchart depicting the agglomeration of the acid soluble isolated protein ingredient with an aqueous soy protein slurry as disclosed in Example 2.

FIG. 3 is a flowchart depicting the agglomeration of the acid soluble isolated protein ingredient with animal source protein slurry as disclosed in Example 3.

FIG. 4 is a flowchart depicting the agglomeration of the acid soluble isolated protein ingredient with carbohydrate hydrocolloid slurry as disclosed in Example 4.

FIG. 5 is a flowchart depicting the simple agglomeration of the acid soluble isolated protein ingredient with a combination of an aqueous soy protein slurry and a hydrocolloid as disclosed in Example 5.

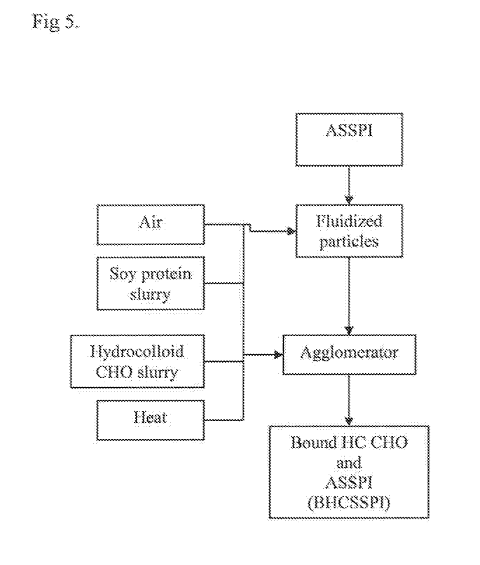

### DETAILED DESCRIPTION OF THE INVENTION

### (I) Compositions

The acid soluble protein for use in the current invention can be an acid soluble protein isolate, an acid soluble protein concentrate, an acid soluble flour and combinations thereof. When an acid soluble protein isolate is used in the agglomerated protein composition, the acid soluble protein isolate may be prepared as described in U.S. Pre-Grant Publication Nos. 20100215830, 20100215830, 20100203205, 20100203204, 20100179305, 20100098818, and 20050255226; all of which are incorporated herein by reference in their entirety.

Acid soluble proteins can be agglomerated by preparing a protein slurry of between about 3% and about 12% and spraying the slurry onto fluidized acid soluble protein particles to create an agglomerated acid soluble protein which can be used to form new protein ingredients with functionality and that can be used in food products.

While the acid soluble protein isolate can be agglomerated with water, it can also be agglomerated with any food product that can be solubilized in spray liquid. Agglomeration yields larger particles because the agglomeration process sticks the particles together. Particle size can be between about 45 μm and about 500 μm. Thus, when the acid soluble protein isolate is combined with water and agglomerated, the particle size of the acid soluble protein isolate increases and the wetability of the acid soluble protein isolate increases. Therefore, the agglomerated acid soluble protein isolate dissolves better in liquid as compared to the acid soluble protein isolate alone.

Complex slurries can be prepared to be added to the acid soluble protein by spraying them in the agglomerator to obtain unique food ingredients with new functionalities suitable to application in food systems. These complex systems can be composed, but are not limited to any combination of the ingredients mentioned in the examples which follow.

The acid soluble protein isolate can be combined with at least one other protein, at least one hydrocolloid, sugar, flavoring agent, vitamin, mineral, lecithin, antioxidant and combinations thereof.

Acid soluble protein isolate can be combine with more conventional soy ingredients and/or other food ingredients such as hydrocolloids, and then co-agglomerated or mixed in wet and spray dried, yielding highly functional food ingredients with unique compositions. This allows the user to tailor make food ingredients for both functional as well as compositional characteristics as requested by consumers and/or customers. The agglomerated protein composition has many applications.

Any protein known by those of ordinary skill in the art to work in food products may be used in the current invention. With regard to a plant protein source, the plant may be grown conventionally or organically. The plant may also be a naturally occurring plant or a genetically engineered plant. By way of non-limiting example, suitable plants may include leguminous plants, corn, peas, canola, sunflowers, sorghum, amaranth, potato, tapioca, arrowroot, canna, lupin, rape, oats, and mixtures thereof.

In particular aspects of the invention, the plant protein source is from soy. The soy protein source may be soybeans or any soy product, by-product, or residue derived from the processing of soybeans including, for example, soy meal, soy spent flakes, soy grits, and soy flour. The soy protein source may be used in the full-fat form, partially defatted form, or fully defatted form. The soy protein recovered from the soy protein source may be the protein naturally occurring in soybean or naturally occurring or modified protein in soybean as a result of genetic engineering. In other aspects of the invention, the soy protein source can be from a soybean with naturally or genetically altered lipid profiles, including for example, high stearic, high oleic, mid oleic, ultra low linolenic, low linolenic, etc. in order to further improve the flavor characteristics and functionality of the soy protein agglomerate.

With the addition of extra protein from an animal or plant source (including, for example, in the form of soy flour, soy protein concentrate, soy protein isolate, or combinations thereof) the nutritional content of the agglomerated protein composition can be tailored to any desired composition, with the advantages of having enhanced levels of calcium.

Addition of other ingredients such as other proteins, including soy, dairy, animal, other plant based proteins and combinations thereof can be achieved by both co-agglomeration or by wet mixing and subsequent spray drying. The acid soluble protein can be combined in this way with other soy protein products, both hydrolyzed and unhydrolyzed, currently available in the market place to increase functionality and/or enhance flavor. The acid soluble protein can also be combined with milk or dairy protein, both hydrolyzed and unhydrolyzed. The acid soluble protein can be combined with starches and/or modified starches; collagen, both hydrolyzed and unhydrolyzed; hydrocolloids, such as, but not limited to pectins, agars, carageenans; and animal proteins such as, but not limited to egg protein, both hydrolyzed and unhydrolyzed.

A variety of additional ingredients may be added without departing from the scope and spirit of the invention. Further additional ingredients include, for example, hydrocolloids, antioxidants, lecithin, colorant, flavoring agent, pH-adjusting agent, and a mineral or amino acid.

(i) Antioxidant

For example, an antioxidant, antimicrobial agent, and combinations thereof may be an additional ingredient. An antioxidant additive includes, for example, BHA, BHT, TBHQ, rosemary extract, vitamins A, C and E and derivatives thereof. Additionally, various plant extracts such as those containing carotenoids, tocopherols or flavonoids having antioxidant properties, may be included to increase the shelf-life or nutritionally enhance the protein compositions. An antioxidant or antimicrobial agent may have a presence or combined presence at levels of from about 0.01% to about 10%, preferably, from about 0.05% to about 5%, and more preferably from about 0.1% to about 2%, by weight of the protein-containing materials.

(ii) Colorant

One or more colorants may be an additional ingredient. The colorant is mixed with the other ingredients or other methods known to one of ordinary skill in the art for coloring food products. Exemplary colorants that can be used are any colorant currently used in the food industry.

(iii) Flavoring Agent

One or more flavoring agents may be an additional ingredient. The flavoring agent may be mixed with the other ingredients or other methods known to one of ordinary skill in the art for flavoring food products. Exemplary flavorings that can be used are any flavoring agents currently used in the food industry.

(iv) Minerals or Amino Acids

One or more minerals or amino acids may be an additional ingredient. Suitable minerals may include one or more minerals or mineral sources. Non-limiting examples of minerals include, without limitation, chloride, sodium, calcium, iron, chromium, copper, iodine, zinc, magnesium, manganese, molybdenum, phosphorus, potassium, selenium, and combinations thereof. Suitable forms of minerals include, for example, soluble mineral salts, slightly soluble mineral salts, insoluble mineral salts, chelated minerals, mineral complexes, non-reactive minerals such as carbonate minerals, reduced minerals, and combinations thereof. Suitable amino acids include, for example, the essential amino acids, i.e., arginine, cysteine, histidine, isoleucine, leucine, lysine, methionine, phenylalanine, threonine, tryptophan, tyrosine, valine, and combinations thereof. Suitable forms of the amino acids include, for example, salts and chelates.

(v) Hydrocolloids

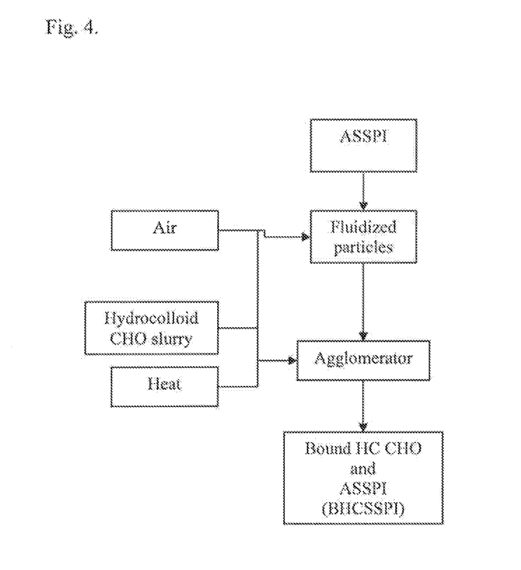

In general hydrocolloids are carbohydrates and are used as stand alone food ingredients, the agglomeration (binding of) these ingredients with acid soluble protein isolate will improve their nutritional quality while improving the functionality of the ingredient, see FIG. 4.

### (III) Food Products

Food products that include the agglomerated protein composition include products in the areas of affordable nutrition, children's nutrition, performance nutrition, and weight management, among others. End use applications include, but are not limited to bars; extruded products such as extrudates or crisps; beverages including dairy, both unfermented and fermented or cultured; dry blended beverages such as drink powders, ready-to drink, both neutral and acidic; and combinations thereof. Any application where soy protein can be used in the form of a soy protein isolate, soy protein concentrate, and/or a soy flour can use the agglomerated soy protein product of the current invention.

### DEFINITIONS

To facilitate understanding of the invention several terms are defined below.

The term “acid soluble protein” refers to a protein that is mostly soluble at acidic pHs (7.0 and lower) more preferably at pH lower than 4.

The term “agglomeration” refers to a method to increase the particle size of powdered food ingredients and material in order to change their physical attributes. It can also be defined as granulation or in some instances solubilization. This is usually achieved by fluidizing the solid particles in an air flow and then spraying them with a liquid to “glue” particles together while applying heat to dry to the desired moisture content.

The term “chelating agent refers to any compound capable of providing negatively charged multivalent ions in solution, or carrying strongly charged groups or regions on its molecule, such that it can react with the positively charges groups on a protein soluble under acid conditions.

The term “colloid” refers to a mixture in which one substance is dispersed evenly throughout another. Colloids can include gels.

The term “hydrocolloid” refers to a substance that forms a colloid with water. Thus any material that forms a colloid when mixed with water is a hydrocolloid, such as but not limited to gum arabic or agar. Hydrocolloids are mostly used to thicken or smooth food products. Hydrocolloids typically form a gel.

The term “flavoring agent” refers to a food additive or ingredient that is added to a food system to enhance or impart a specific flavor or flavors

The term “vitamin” refers to any of various organic substances that are essential in minute quantities to the nutrition of most animals and some plants, act especially as coenzymes and precursors of coenzymes in the regulation of metabolic processes but do not provide energy or serve as building units, and are present in natural foodstuffs or sometimes produced within the body The term “antioxidant” refers to a substance that inhibits oxidation or reactions promoted by oxygen, peroxides, or free radicals.

The term “salt” refers to Ionic compounds that can be formed by replacing one or more of the hydrogen ions of an acid with another positive ion.

The term “sequestrant” is a food additive whose role is to improve the quality and stability of the food products. Sequestrants form chelate complexes with polyvalent metal ions, especially copper, iron, and nickel, which serve as catalysts in the oxidation of the fats in the food.

The term “sugar” refers to any of various water-soluble compounds that vary widely in sweetness, including monosaccharides and oligosaccharides.

The terms “soy protein isolate” or “isolated soy protein,” as used herein, refer to a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to a comminuted form of defatted, partially defatted, or full fat soybean material having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen.

The following examples are used herein to illustrate different aspects of this invention and are not meant to limit the present invention in any way. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the application is to be interpreted as illustrative and not in a limiting sense.

As used herein, “a” or “an” may mean one or more. As used herein when used in conjunction with the word “comprising,” the words “a” or “an” may mean one or more than one. As used herein “another” may mean at least a second or more. Furthermore, unless otherwise required by context, singular terms include pluralities and plural terms include the singular.

As used herein, “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, “comprising” and all its forms and tenses (including, for example, comprise and comprised) is synonymous with “including,” “containing,” or “characterized by,” and is inclusive or open-ended language and does not exclude an additional, unrecited element, step, or ingredient. As used herein, “consisting” and all its forms and tenses (including, for example, consist and consisted) is closed language and excludes any element, step, or ingredient not specified. As used herein, “consisting essentially of” and all its forms and tenses limits the scope of the invention to the specified element, step, or ingredient and those that do not materially affect the basic and novel characteristic(s) of the claimed invention. Applicants note that certain embodiments recite the transitional phrase “comprising.” Wherever this transitional phrase has been recited, the transitional phrase consisting or consisting essentially of have also been contemplated by the inventors and form part of the invention.

All patents and publications mentioned in this specification are indicative of the level of those skilled in the art to which the invention pertains. All patents and publications herein are incorporated by reference to the same extent as if each individual publication was specifically and individually indicated as having been incorporated by reference in its entirety.

### EXAMPLES

The examples are illustrative and are not meant to limit the present invention in any way and many changes that can be made without departing from the spirit and scope of the invention would be apparent to those skilled in the art.

### Example 1

### Simple Agglomeration of Acid Soluble Soy Protein Ingredient

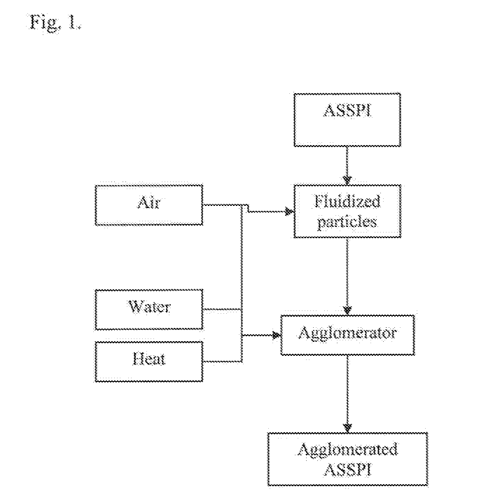

1000 grams of acid soluble soy protein isolate were loaded into the agglomerator chamber and air flow at a rate of 45 CFM (cubic feet per minute) was applied in order to fluidize the fine powder particles, once the particles were suspended in the chamber, water was added in a proportion of about 1% to about 40% (based on the initial dry powder load weight) and hot air was applied into the chamber at 88° C., this temperature was maintained constant throughout the duration of the experiment, the filter pulse was set to 10 seconds, and the water spray rate was 40 gram per minute, this operation was performed for 7 minutes for a total sprayed water of 280 grams. Different particle sizes are achieved depending upon the amount of water and time of the operation, the more water and the longer the time of operation the larger the agglomerated particles see FIG. 1.

In this specific example the obtained agglomerated powder had a moisture content of 4.54%, and an as is protein content of 97.77%. The agglomerated soy protein isolate (ASPI) obtained is significantly more dispersible 91 mL than the starting material 90. As a consequence, when dispersed in water the resulting ASPI was significantly easier to disperse than the original powder. The ASPI had a larger mean particle size 108 μm than the starting material (25 μm). The ASPI had 0.23 g/cc bulk density versus 0.25 g/cc bulk density of the starting material, and was easier to handle due to its flow ability (less dusting).

The material obtained in this example is a useful food ingredient in many food systems including, but not limited to: Soft drinks, coffee, fruit juice, fruit drinks, barbeque sauce, ketchup, jellies, jams, fruit curds, nutritional sports drinks and combinations thereof.

### Example 2

### Agglomeration of Acid Soluble Soy Protein Isolate with an Aqueous Soy Protein Slurry

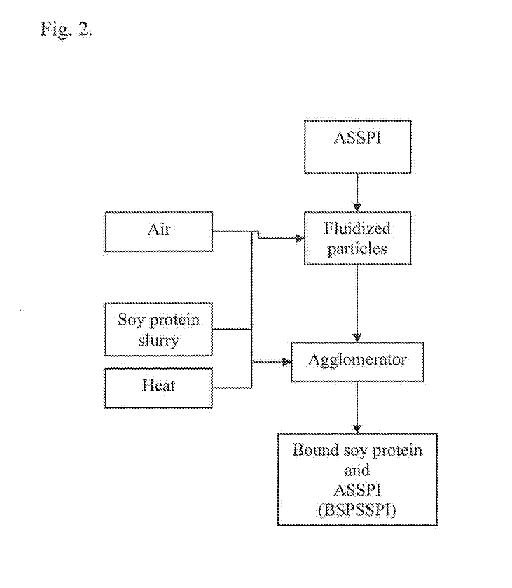

110 grams of SUPRO®500E soy protein isolate was dispersed in 700 grams of tap water and sprayed into the agglomerator chamber that was previously loaded with 1000 grams of acid soluble soy protein isolate, see FIG. 2.

Air flow at an initial rate of 45 CFM (cubic feet per minute) was applied in order to fluidize the fine powder particles, once the particles were suspended in the chamber, the above described protein slurry was sprayed, and hot air was applied into the chamber at 88° C., this temperature was maintained constant throughout the duration of the experiment, the filter pulse was set to 10 seconds, and the SUPRO®500E slurry spray rate was set to 40 grams per minute, after one minute the air flow rate was adjusted to 55 CFM and this operation was performed for an additional 20 minutes.

In this specific example the obtained agglomerated powder had a moisture content of 4.07%, and a protein content of 95.78%. The ASPI obtained had a dispersibility of 85 mL. The ASPI had a larger mean particle size 57 μm than the starting material (25 μm). The ASPI had 0.30 g/cc bulk density versus 0.25 g/cc bulk density of the starting material, and was easier to handle due to its flow ability (less dusting).

The material obtained in this example is a useful food ingredient in many food systems including, but not limited to: Soft drinks, coffee, fruit juice, fruit drinks, barbeque sauce, ketchup, jellies, jams, fruit curds, nutritional sports drinks and combinations thereof.

### Example 3

### Agglomeration of Acid Soluble Soy Protein Isolate with Animal Source Protein Slurry

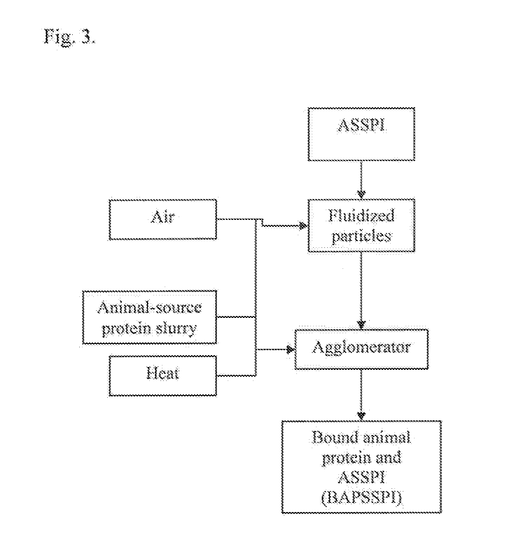

50 grams of gelatin hydrolyzate was dispersed in 280 grams of tap water and sprayed into the agglomerator chamber that was previously loaded with 1000 grams of acid soluble soy protein isolate, see FIG. 3.

Air flow at an initial rate of 45 CFM (cubic feet per minute) was applied in order to fluidize the fine powder particles, once the particles were suspended in the chamber, the above described protein hydrolyzate slurry was sprayed, and hot air was applied into the chamber at 88° C., this temperature was maintained constant throughout the duration of the experiment, the filter pulse was set to 10 seconds, and the gelatin hydrolyzate slurry spray rate was set to 40 gram per minute, after five minutes the air flow rate was adjusted to 55 CFM, and subsequently after one more minute re-adjusted to 65 CFM, and this operation was performed for an additional 2.5 minutes for a total run time of 8.5 minutes.

In this specific example the obtained agglomerated powder had a moisture content of 4.86%, and an as is protein content of 98.86%. The ASPI obtained had a dispersibility of 90 mL. The ASPI had a larger mean particle size 47 μm than the starting material (25 μm). The ASPI had 0.28 g/cc bulk density versus 0.25 g/cc bulk density of the starting material, and was easier to handle due to its flow ability (less dusting).

The material obtained in this example is a useful food ingredient in many food systems including, but not limited to: Soft drinks, coffee, fruit juice, fruit drinks, barbeque sauce, ketchup, jellies, jams, fruit curds, nutritional sports drinks, smoothies, cereal bars, pudding, frozen desserts, soups, sauces, canned fruits, meat products, and combinations thereof.

### Example 4

### Agglomeration of Acid Soluble Soy Protein Isolate with Carbohydrate Hydrocolloid Slurry

A 3% agar slurry is sprayed on the acid soluble soy protein loaded into the chamber of the agglomerator to obtain a food ingredient product that contained 5% of agar and 95% of acid soluble soy protein isolate, the food ingredient will have significantly better thickening and gelling properties than the acid soluble soy protein. This food ingredient is suitable for confectionery and frozen dessert applications and is very dispersible in aqueous food systems, see FIG. 4.

### Example 5

### Agglomeration of Acid Soluble Soy Protein Isolate with a Combination of an Aqueous Soy Protein Slurry and a Hydrocolloid

50 grams of pectin and 50 grams of SUPRO® 500E soy protein isolate were dispersed in 1000 grams of tap water and sprayed into the agglomerator chamber that was previously loaded with 900 grams of acid soluble soy protein isolate

Air flow at an initial rate of 45 CFM (cubic feet per minute) was applied in order to fluidize the fine powder particles, once the particles were suspended in the chamber, the above described protein/pectin slurry was sprayed, and hot air was applied into the chamber at 88° C., this temperature was maintained constant throughout the duration of the experiment, the filter pulse was set to 10 seconds, and the soy protein/pectin slurry spray rate was set to 40 gram per minute, after five minutes the air flow rate was adjusted to 60 CFM, and this operation was performed for an additional 23 minutes for a total run time of 28 minutes, which were needed to spray the totality of the prepared soy protein/pectin slurry.

In this specific example the obtained agglomerated powder had a moisture content of 3.2%, and an as is protein content of 97.06%. The ASPI obtained had a dispersibility of 85 mL. The ASPI had a larger mean particle size 118 μm than the starting material (25 μm). The ASPI had 0.27 g/cc bulk density versus 0.25 g/cc bulk density of the starting material, and was easier to handle due to its flow ability (less dusting).

The material obtained in this example is a useful food ingredient in many food systems including, but not limited to: Soft drinks, coffee, fruit juice, fruit drinks, barbeque sauce, ketchup, jellies, jams, fruit curds, nutritional sports drinks, smoothies, cereal bars, pudding, frozen desserts, soups, sauces, canned fruits, meat products and combinations thereof.

### Example 6

### Agglomeration of Acid Soluble Soy Protein Isolate with a Chelating Agent

86 grams of Sodium-Hexametaphosphate was dissolved in 280 grams of tap water and sprayed into the agglomerator chamber that was previously loaded with 1000 grams of acid soluble soy protein isolate.

Air flow at an initial rate of 45 CFM (cubic feet per minute) was applied in order to fluidize the fine powder particles, once the particles were suspended in the chamber, the above described salt solution was sprayed, and hot air was applied into the chamber at 88° C., this temperature was maintained constant throughout the duration of the experiment, the filter pulse was set to 10 seconds, and the salt solution spray rate was set to 40 gram per minute, after two minutes the air flow rate was adjusted to 55 CFM, and a minute later to 65 CFM this operation was performed for an additional 6.5 minutes for a total run time of 9.5 minutes, which were needed to spray the totality of the prepared salt solution.

In this specific example the obtained agglomerated powder had a moisture content of 2.65%, and an as is protein content of 88.42. The ASPI obtained had a dispersibility of 83 mL. The ASPI had a larger mean particle size 94 μm than the starting material (25 μm). The ASPI had 0.28 g/cc bulk density versus 0.25 g/cc bulk density of the starting material, and was easier to handle due to its flow ability (less dusting).

The material obtained in this example is a useful food ingredient in many food systems including, but not limited to: salad dressings, gravy, sauces, dry blended beverages, ready to drink beverages, puddings, frozen desserts, yoghurts, icings, baked cakes, pastries, breads, injected meats, cookies, pancakes, and combinations thereof.

### Example 7

### Co-Agglomeration of Acid Soluble Soy Protein Isolate with Combination on Ingredients to Produce a Protein-Rich Flavored Acid Soluble Food Ingredient

150 g sucrose, 25 g of a combination of Orange, Pineapple, and Banana, Flavoring, and 0.6 g of Orange Shade colorant was dissolved in 250 grams of tap water and sprayed into the agglomerator chamber that was previously loaded with 995 grams of acid soluble soy protein isolate and 5 grams of pectin powder,

Air flow at an initial rate of 45 CFM (cubic feet per minute) was applied in order to fluidize the fine powder particles, once the particles were suspended in the chamber, the above described solution (combination of sucrose, flavoring agents and colorant) was sprayed, and hot air was applied into the chamber at 88° C., this temperature was maintained constant throughout the duration of the experiment, the filter pulse was set to 10 seconds, and the above described solution spray rate was set to 40 gram per minute, after 8 minutes the air flow rate was adjusted to 55 CFM, and a minute later to 60 CFM this operation was performed for an additional 13 minutes for a total run time of 22 minutes, which were needed to spray the totality of the prepared solution.

In this specific example the obtained agglomerated powder had a moisture content of 3.79%, and an as is protein content of 88.86%. The ASPI obtained is significantly more dispersible 95 than the starting material 90. As a consequence, when dispersed in water the resulting ASPI-rich food ingredient was significantly easier to disperse than the original powder, producing a more homogeneous dispersion. The ASPI had a larger mean particle size 71 μm than the starting material (25 μm). The ASPI had 0.23 g/cc bulk density versus 0.25 g/cc bulk density of the starting material, and was easier to handle due to its flow ability (less dusting).

The flavored protein-rich material produced in this example is acid soluble and can be used for, but are not limited to the following applications: beverage blends, ready to drink beverages, fruit purees, fruit fillings, fruit curds, yoghurt, frozen desserts, parfaits, and combinations thereof.

### Example 8

### Co-Agglomeration of Acid Soluble Soy Protein Isolate with Combination on Ingredients to Produce a Protein-Rich Chocolate-Flavored Water-Soluble Food Ingredient

200 g sucrose, 60 g of sodium-Hexametaphosphate and 30 g of Chocolate Flavorin was dissolved in 350 grams of tap water and sprayed into the agglomerator chamber that was previously loaded with 600 grams of acid soluble soy protein isolate, 216 g coco powder, 100 g of granulated sucrose, and 1 g of Pectin powder.

Air flow at an initial rate of 65 CFM (cubic feet per minute) was applied in order to fluidize the fine powder particles, once the particles were suspended in the chamber, the above described solution (combination of sucrose, flavoring agents and complex salt) was sprayed, and hot air was applied into the chamber at 88° C., this temperature was maintained constant throughout the duration of the experiment, the filter pulse was set to 10 seconds, and the above described solution spray rate was set to 30 gram per minute, after 2 minutes the air flow rate was adjusted to 85 CFM, and this operation was performed for an additional 20 minutes for a total run time of 22 minutes, which were needed to spray the prepared solution.

In this specific example the obtained agglomerated powder had a moisture content of 3.48%, and an as is protein content of 56.27%. The ASPI is significantly more dispersible 100 than the starting material 90. As a consequence, when dispersed in water the resulting ASPI-rich food ingredient was significantly easier to disperse than the original powder, producing a more homogeneous dispersion. The ASPI had a larger mean particle size 114 μm than the starting material (25 μm). The ASPI had 0.36 g/cc bulk density versus 0.25 g/cc bulk density of the starting material, and was easier to handle due to its flow ability (less dusting).

The flavored protein-rich material produced in this example is water soluble and can be used for, but are not limited to the following applications: yoghurt, nutritional sport drinks, puddings, oatmeal, cereal, frozen desserts, chocolate sauces, toppings.

### Example 9

### Low pH (acid) Dry Blended Beverage (Weight Loss Dry Mix) Containing Agglomerated Acid Soluble Isolated Soy Protein (AASISP)

TABLE 1
Weight-loss dry mix formula

Batch size
500 g

| Ingredients: | g/serving | % | g/batch |
|---|---|---|---|
| AASISP | 13.00 | 37.08 | 185.40 |
| Whey Protein Isolate WPI | 5.00 | 14.26 | 71.31 |
| Sucrose | 8.50 | 24.24 | 121.22 |
| Digestion resistant | 4.00 | 11.41 | 57.05 |
| maltodextrin | | | |
| Fat Powder (65.5% Fat) | 2.00 | 5.70 | 28.52 |
| Xanthan gum | 0.20 | 0.57 | 2.85 |
| Stevia | 0.95 | 2.71 | 13.55 |
| Potassium Citrate | 0.40 | 1.14 | 5.70 |
| Vitamin Premix | 0.16 | 0.46 | 2.28 |
| Mixed Berry Flavour | 0.85 | 2.42 | 12.12 |
| Total: | 35.06 | 100.00 | 500.00 |

The AASISP is added to a v-blender, together with the sodium hexametaphosphate and the sodium carbonate and blended for 10 minutes

The rest of the ingredients are added to the blender and the mix is blended for a further 10 minutes

The powder mix is discharged from the blender and packaged into individual sachets and heat sealed. Approximately 35 g of mixture is placed in each sachet.

The resulting product is stirred or shaken into 230 ml (8 fluid ounces) of water until smooth (several minutes) to replace a meal as part of a weight loss programme

### Example 10

### Protein Extrudates Containing the Agglomerated Acid Soluble Soy Protein Composition

In this Example, the agglomerated acid soluble isolated soy protein (AASISP) is used to prepare a soy protein extrudate. A soy protein extrudate having approximately 87 wt. % protein is prepared. The extrudate is produced by introducing the ingredients of the protein-containing feed mixture formulation into a mixing tank to combine the ingredients and form a protein feed pre-mix. The pre-mix is then transferred to a hopper, where the pre-mix is held for feeding via screw feeder to a pre-conditioner to form a conditioned feed mixture by injecting steam and water, as known by one skilled in the art. The conditioned feed mixture is then fed to an extruder a long with fluids as needed and known by one skilled in the art. The feed mixture is heated by mechanical energy generated by the rotation of the screws of the extruder to form a molten extrusion mass. The molten extrusion mass exits the extruder through an extrusion die. The feed mixture is described in Table 2.

TABLE 2

| | Formula |
|---|---|
| AASISP (wt. %) | 99.4 |
| Dicalcium Phosphate or | 0.3 |
| Calcium Carbonate(wt. %) | |
| Soy Lecithin (wt. %) | 0.3 |

The ingredients of the feed mixture are mixed in an ingredient blender until uniformly distributed. The dry feed mixture is then conveyed to an extruder, such as a Wenger Magnum TX52 extruder and processed as describe above to make extrudates.

TABLE 3

| Formulation | | |
|---|---|---|
| Information | | Soy Nuggets |
| Extrusion | | Wenger TX-52 |
| Parameters | | |
| Dry Formula Feed Rate | (kg/hr) | 50-80 |
| Cylinder Steam | (kg/hr) | 3.0-5.0 |
| Cylinder Water | (kg/hr) | 5.0-15.0 |
| Extruder Water | (kg/hr) | 10.0-20.0 |
| Extruder Screw Speed | RPM | 250-700 |
| Knife Speed | RPM | 2000-3000 |
| SME (Specific | kwh/hr | 45-125 |
| Mechanical Energy) | | |
| Down Spout | (° C.) | 40-65 |
| Temperature | | |
| Zone #1 Temperature | (° C.) | 35-55 |
| Zone #2 Temperature | (° C.) | 40-85 |
| Zone #3 Temperature | (° C.) | 100-120 |
| Zone #4 Temperature | (° C.) | 100-120 |
| Head Pressure | (PSI) | 300-850 |
| National Dryer | | |
| Information | | |
| Temperature of the | (° F.) | 240-310 |
| Dryer-Zone 1 | | |
| Time in the Dryer | (min) | 10-20 |

### Example 11

### A Food Bar Containing the Soy Protein Material

In this Example, samples of high protein food bars comprising proteinaceous material and sugar syrups are produced.

To obtain the high protein food bars, a first mixture is produced in a Winkworth mixer (available from Winkworth Machinery, Ltd., Reading, England) mixing at a speed of 48 revolutions per minute (rpm) for one minute. The first mixture comprises: 600.0 grams agglomerated acid soluble isolated soy protein (AASISP) material, 32.4 grams rice syrup solids (available from Natural Products, Lathrop, Calif.), 76.4 grams cocoa powder (available from DeZaan, Milwaukee, Wis.), 10.5 grams vitamin & mineral premix (available from Fortitech®, Schenectady, N.Y.), and 1.6 grams salt.

In a separate container, a second mixture containing liquid sugar syrups and liquid flavoring agents is then heated to a temperature of 37.8° C. (100° F.) by microwaving on high power for about 45 seconds. The liquid sugar syrup consists of 710.0 grams of a 55:45 blend of 63 DE corn syrup (available from Roquette®, LESTREM Cedex, France) to high fructose corn syrup 55 (available from International Molasses Corp., Rochelle Park, N.J.) and 566.0 grams glycerin. The liquid flavoring agents consist of 4.1 grams Edlong® Chocolate flavor 610 (available from The Edlong® Corporation, Elk Grove Village, Ill.), 4.1 grams Edlong® Chocolate flavor 614 (available from The Edlong® Corporation, Elk Grove Village, Ill.), and 2.0 grams vanilla flavoring (available from Sethness Greenleaf, Inc., Chicago, Ill.). The heated second mixture is then mixed the first mixture in a Winkworth mixer at a speed of 48 rpm for three minutes and forty-five seconds. The resulting dough is then sheeted out onto a marble slab and bars are cut into pieces weighing from about 45 grams to about 55 grams (the bar pieces are 102 millimeters in length. 10 millimeters in height, and 35 millimeters wide).

While the invention has been explained in relation to exemplary embodiments, it is to be understood that various modifications thereof will become apparent to those skilled in the art upon reading the description. Thereof it is to be understood that the invention disclosed herein is intended to cover such modifications as fail within the scope of the appealed claims.

What is claimed is:

1. An agglomerated protein composition, wherein the composition comprises:
a. at least one acid soluble soy protein isolate, and
b. water, and the composition has a particle size between about 45 μm and about 500 μm.

2. An agglomerated protein composition, wherein the composition comprises:
a. at least one acid soluble soy protein isolate, and
b. at least one other protein.

3. The composition of claim 2, wherein the composition has a particle size between about 45 μm and about 500 μm.

4. The composition of claim 2, wherein the at least one other protein is selected from the group consisting of vegetable proteins, animal proteins, dairy proteins and combinations thereof.

5. The composition of claim 1, further comprising at least one of the following:
hydrocolloid, sugar, flavoring agents, vitamins, antioxidants, and combinations thereof.

6. The composition of claim 2, further comprising at least one of the following:
hydrocolloid, sugar, flavoring agents, vitamins, antioxidants, and combinations thereof.

7. An agglomerated composition, wherein the composition comprises:
a. an acid soluble soy protein isolate, and
b. at least one of the following: hydrocolloid, sugar, flavoring agent, vitamin, antioxidant, and combinations thereof.

8. A food product comprising the agglomerated protein composition of claim 1.

9. A food product comprising the agglomerated protein composition of claim 2.

10. The food product of claim 8 wherein the food product is selected from the group consisting of beverage blends, ready-to-drink beverages, soft drinks, coffee, fruit juice, fruit drinks, nutritional sports beverages, smoothies, dry blended beverages, cereal bars, extrudates, food bars and combination thereof.

11. The food product of claim 9 wherein the food product is selected from the group consisting of beverage blends, ready-to-drink beverages, soft drinks, coffee, fruit juice, fruit drinks, nutritional sports beverages, smoothies, dry blended beverages, cereal bars, extrudates, food bars and combination thereof.
